(19) United States
(12) Patent Application Publication
(10) Pub. No.: US 2022/0350557 A1
(43) Pub. Date: Nov. 3, 2022

(54) DISPLAY APPARATUS

(71) Applicant: Panasonic Intellectual Property Management Co., Ltd., Osaka (JP)

(72) Inventors: Yasuhiro TAKADA, Kanagawa (JP); Hiroya OUE, Kanagawa (JP); Masao ENDO, Kanagawa (JP)

(73) Assignee: Panasonic Intellectual Property Management Co., Ltd., Osaka (JP)

(21) Appl. No.: 17/731,918

(22) Filed: Apr. 28, 2022

(30) Foreign Application Priority Data
Apr. 30, 2021 (JP) 2021-077719

(51) Int. Cl. G06F 3/14; G06T 3/40; B60K 35/00

(52) U.S. Cl. CPC G06F 3/14; G06T 3/40; B60K 35/00; B60K 2370/349; B60K 2370/152; B60K 2370/167

(57) ABSTRACT

A display panel is capable of displaying a meter image that includes a pointer image constituting a pointer and a mark image constituting a mark pointed to by the pointer. A display controller controls a display state of the display panel. The display panel simultaneously displays a plurality of meter images including a first meter image and a second meter image and a background image encircling the plurality of meter images and is capable of switching the first meter image to a third meter image, which is the meter image of a type different from the first meter image, and displaying the third meter image. The display controller changes a display mode of at least one of the second meter image, the third meter image, or the background image when switching the first meter image to the third meter image and displaying the third meter image on the display panel.

### BACKGROUND

### 1. Field

The present invention relates to a display apparatus.

### 2. Description of the Related Art

In a display apparatus for a vehicle, a meter image representing a meter is displayed on a display panel (e.g., patent literature 1).

[Patent Literature 1] JP2008-241472

In a display apparatus, it is possible to display a plurality of types of meter images of a fuel meter, a speed meter, etc. switchably in accordance with the driving condition, setting, etc. It is desired to make it easy to understand what meter image is displayed in the display apparatus.

### SUMMARY

The present disclosure addresses the above-described issue, and a purpose thereof is to provide a technology that facilitates recognition of the switching of meter images.

A display apparatus according to an embodiment of the present disclosure includes: a display panel capable of displaying one or more meter images, each of the one or more meter images includes a pointer image constituting a pointer and a mark image constituting a mark pointed to by the pointer; and a display controller that controls a display state of the display panel. The one or more meter images include a plurality of meter images, the display panel simultaneously displays the plurality of meter images including a first meter image and a second meter image and a background image encircling the plurality of meter images and is capable of switching from a first state of displaying the first meter image to a second state of displaying a third meter image, the third image is a meter image of a type different from the first meter image, and the display controller changes a display mode of at least one of the second meter image, the third meter image, or the background image when switching from the first state to the second state. “Changing the display mode of the third meter image” means displaying the third meter image in a display mode which is different from the display mode of the first meter image.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 shows a structure of a vehicle interior of a vehicle according to an embodiment;

FIG. 2 shows a configuration of the display apparatus of FIG. 1;

FIGS. 3A-3B show a basic configuration of a meter screen displayed on the display panel of FIG. 2;

FIGS. 4A-4B show examples of the meter screen displayed on the display panel of FIG. 2;

FIGS. 5A-5D show further examples of the meter screen displayed on the display panel of FIG. 2;

FIGS. 6A-6B show further examples of the meter screen displayed on the display panel of FIG. 2;

FIGS. 7A-7B show still further examples of the meter screen displayed on the display panel of FIG. 2;

FIGS. 8A-8D show still further examples of the meter screen displayed on the display panel of FIG. 2;

FIGS. 9A-9B show still further examples of the meter screen displayed on the display panel of FIG. 2;

FIGS. 10A-10D show still further examples of the meter screen displayed on the display panel of FIG. 2;

FIGS. 11A-11D show still further examples of the meter screen displayed on the display panel of FIG. 2;

FIGS. 12A-12C show still further examples of the meter screen displayed on the display panel of FIG. 2;

FIGS. 13A-13D show still further examples of the meter screen displayed on the display panel of FIG. 2;

FIG. 14 shows a still further example of the meter screen displayed on the display panel of FIG. 2; and

FIG. 15 is a flowchart showing a sequence of displaying steps in the display apparatus of FIG. 2.

### DETAILED DESCRIPTION

The invention will now be described by reference to the preferred embodiments. This does not intend to limit the scope of the present invention, but to exemplify the invention.

A summary of the embodiment will be given before describing the embodiment in specific details. The embodiment relates to a display apparatus for electronically displaying images of various meters on an instrument panel of a vehicle. Hereinafter, images showing various meters will be referred to as “meter images”. The display apparatus displays a plurality of types of meter images switchably. For example, the display apparatus switches from a fuel meter to an average fuel cost meter. In that process, the driver will find it useful if he or she can discern the switching between meter images instantly. For example, the color around the pointer may be changed to a different color when a meter image is switched to another type of meter image. In this embodiment, not only the color around the pointer but also the color of the pointer or mark or dial face may be changed, or the shape, as well as the color, of the pointer or the layout or design of the meter image may be changed to make it even easier to recognize the switching of the meter image.

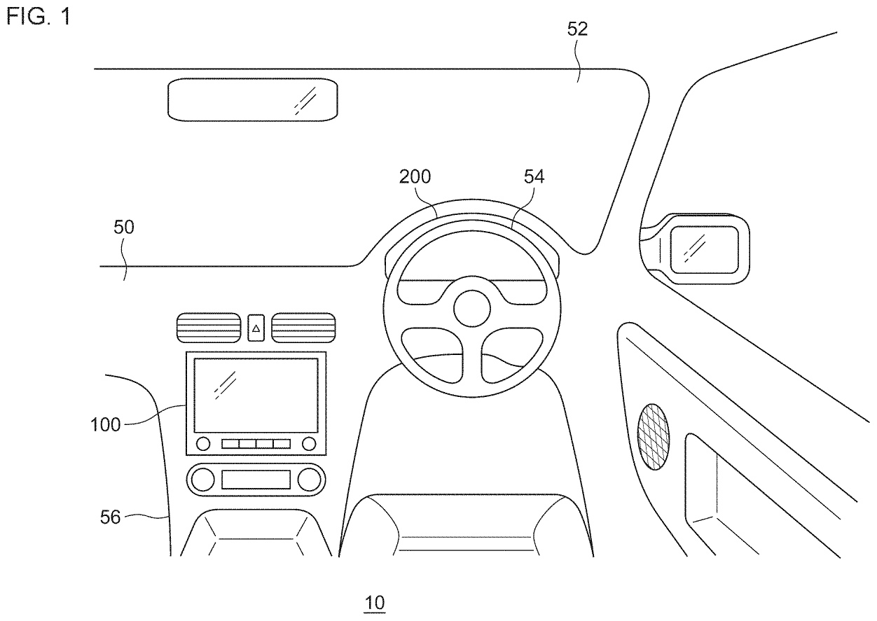

FIG. 1 shows a structure in a vehicle interior of a vehicle 10. A windshield 52 is provided in front of a dashboard 50 provided frontward in the vehicle interior. A steering wheel 54 is provided to the right of the dashboard 50. The steering wheel 54 may be provided to the left of the dashboard 50. A display apparatus 20 is provided in front of the steering wheel 54, and, for example, in an instrument panel of the vehicle 10. The display apparatus 200 is also referred to as an electronically displayed meter. A center console 56 extending vertically is provided in the central portion of the dashboard 50. A vehicle-mounted monitor 100 is set within the center console 56. The vehicle-mounted monitor 100 displays, for example, a map image of a car navigation system.

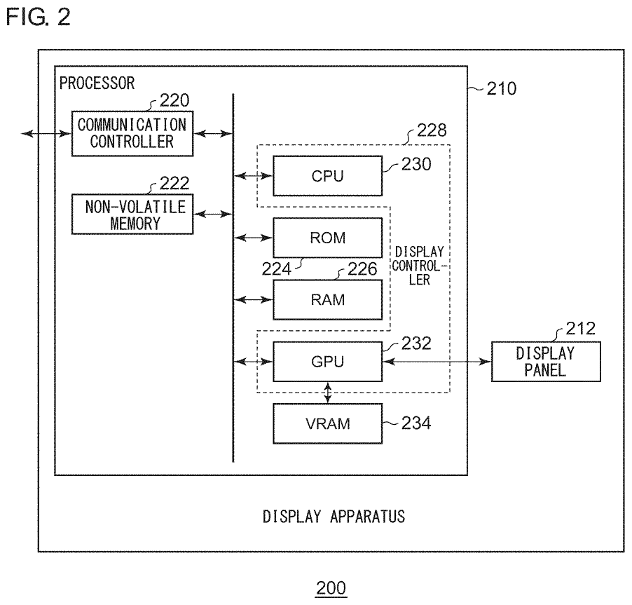

FIG. 2 shows a configuration of the display apparatus 200. The display apparatus 200 includes a processor 210 and a display panel 212. The processor 210 includes a communication controller 220, a non-volatile memory 222, a ROM 224, a RAM 226, a central processing unit (CPU) 230, a graphics processing unit (GPU) 232, and a video random access memory (VRAM) 234. The CPU 230 and the GPU 232 may be packaged as a display controller 228.

The communication controller 220 receives vehicle information from various electronic control units (ECU) and various sensors via a vehicle-mounted network in accordance with a predetermined communication standard. The vehicle-mounted network is exemplified by a controller area network (CAN). For example, the communication controller 220 receives fuel information from an ECU connected to a fuel sensor, receives vehicle speed information from an ECU connected to a vehicle speed sensor, and receives engine revolution information from an ECU for managing the engine. Further, the communication controller 220 receives average fuel cost information from an ECU. Further, the communication controller 220 is connected to an interface for acquiring information necessary for screen display from the driver. The communication controller 220 outputs the vehicle information received to the CPU 230.

The non-volatile memory 222 is a large capacity storage. For example, a flash memory or a hard disk is used as the non-volatile memory 222. The non-volatile memory 222 stores various application programs and various data. The non-volatile memory 222 also stores image data. The image data is inclusive of, for example, vertex data, texture data, polygon data, etc. of the parts constituting an image. The ROM 224 is a read-only non-volatile memory and stores firmware and basic data. The ROM 224 can store programs, image data, and polygon data that need not be rewritten. The RAM 226 is a read/write enabled volatile memory and is used as a work area of the CPU 230. The CPU 230 reads the program and data from the non-volatile memory 222 and the ROM 224 into the RAM 226 and performs various processes.

The GPU 232 is a custom IC specialized for image processes such as image rendering and color correction and generates an image that should be displayed on the display panel 212. The VRAM 234 is a read/write enabled volatile memory and is used as a work area of the GPU 232. For example, the VRAM 234 has an area for storing data dealt with in the GPU 232, a storage area for reading texture data, and a frame buffer area. The VRAM 234 stores polygon data and textures. The VRAM 234 may be incorporated into the RAM 226.

The display controller 228, which includes the CPU 230 and the GPU 232, generates a meter screen showing a plurality of meters based on the vehicle information received from the communication controller 220. The meter screen generated in the display controller 228 will be described later. The display controller 228 displays the meter screen generated on the display panel 212. When the vehicle information received is updated, the display controller 228 updates the meter screen and displays the updated information on the display panel 212. Thus, the display controller 228 controls the display state of the display panel 212. The display panel 212 is a display. The display panel 212 is, for example, a liquid crystal display or an organic EL display. The display panel 212 displays an image output from the processor 210, i.e., a meter screen rendered by the GPU 232 in the frame buffer.

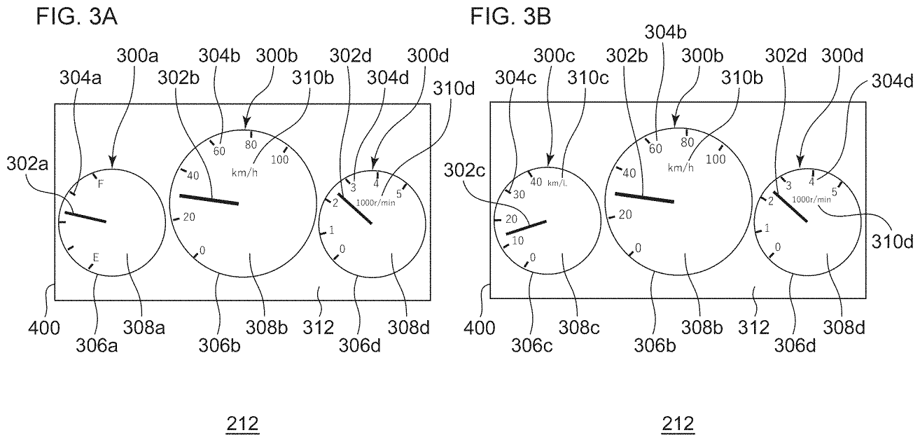

To describe a meter screen generated by the display controller 228 and displayed on the display panel 212, FIGS. 3A-3B will also be used. FIGS. 3A-3B show a basic configuration of a meter screen 400 displayed on the display panel 212. A first meter image 300a is provided at the left end of the meter screen 400 shown in FIG. 3A, a second meter image 300b is provided to the right of the first meter image 300a, and a fourth meter image 300d is provided to the right of the second meter image 300b. The first meter image 300a, the second meter image 300b, and the fourth meter image 300d are generically referred to as meter images 300. A background image 312 is provided in the meter screen 400 to encircle the plurality of meter images 300. In this way, a plurality of meter images 300 and the background image 312 are displayed simultaneously in the meter screen 400. The number of meter images 300 in FIG. 3A is “3”, but the number of meter images 300 may be “2”. In that case, the fourth meter image 300d is omitted. Alternatively, the number of meter images 300 may be “4” or more.

The first meter image 300a is, for example, an image of a fuel meter. The first meter image 300a includes a first pointer image 302a, a first mark image 304a, a first outer frame image 306a, and a first dial face image 308a. The first pointer image 302a constitutes a pointer. The first mark image 304a constitutes a mark pointed to by the first pointer image 302a. The first outer frame image 306a constitutes a circular outer frame encircling the first mark image 304a. The first dial face image 308a constitutes a dial face positioned inside the first mark image 304a. The display controller 228 of FIG. 2 determines the angle of the first pointer image 302a relative to the first mark image 304a based on the fuel information received from the communication controller 220 and generates the first meter image 300a in which the first pointer image 302a is oriented in the angle determined.

The second meter image 300b is, for example, an image of a speed meter. The second meter image 300b includes a second pointer image 302b, a second mark image 304b, a second outer frame image 306b, a second dial face image 308b, and a second unit image 310b. The second pointer image 302b, the second mark image 304b, the second outer frame image 306b, and the second dial face image 308b are shown in a manner similar to that of the first pointer image 302a, the first mark image 304a, the first outer frame image 306a, and the first dial face image 308a, respectively. The second unit image 310b shows a unit of the mark. The display controller 228 of FIG. 2 determines the angle of the second pointer image 302b relative to the second mark image 304b based on the speed information received from the communication controller 220 and generates the second meter image 300b in which the second pointer image 302b is oriented in the angle determined.

The fourth meter image 300d is, for example, an image of a tachometer. The fourth meter image 300d includes a fourth pointer image 302d, a fourth mark image 304d, a fourth outer frame image 306d, a fourth dial face image 308d, and a fourth unit image 310d. The fourth pointer image 302d, the fourth mark image 304d, the fourth outer frame image 306d, the fourth dial face image 308d, and the fourth unit image 310d are shown in a manner similar to that of the second pointer image 302b, the second mark image 304b, the second outer frame image 306b, the second dial face image 308b, and the second unit image 310b, respectively. The display controller 228 of FIG. 2 determines the angle of the fourth pointer image 302d relative to the fourth mark image 304d based on the revolution information received from the communication controller 220 and generates the fourth meter image 300d in which the fourth pointer image 302d is oriented in the angle determined.

The display controller 228 can switch the first meter image 300a to a meter image 300 of a type different from the first meter image 300a in the meter screen 400 (e.g., a third meter image 300c). The third meter image 300c is an image of a meter different from the fuel meter. FIG. 3B shows a post-switching meter screen 400. At the left end of the meter screen 400 shown in FIG. 3B, the third meter image 300c is provided in place of the first meter image 300a of FIG. 3A. The second meter image 300b and the fourth meter image 300d are provided to the right of the third meter image 300c, as in FIG. 3A. Referring to FIG. 3B, the background image 312 is provided in the meter screen 400 to encircle the plurality of meter images 300, i.e., the second meter image 300b, the fourth meter image 300d, and the third meter image 300c.

The third meter image 300c is, for example, an image of an average fuel cost meter. The third meter image 300c includes a third pointer image 302c, a third mark image 304c, a third outer frame image 306c, a third dial face image 308c, and a third unit image 310c. The third pointer image 302c, the third outer frame image 306c, and the third dial face image 308c, and the third unit image 310c are shown in a manner similar to that of the second pointer image 302b, the second mark image 304b, the second outer frame image 306b, the second dial face image 308b, and the second unit image 310b, respectively. The display controller 228 of FIG. 2 determines the angle of the third pointer image 302c relative to the third mark image 304c based on the average fuel cost information received from the communication controller 220 and generates the third meter image 300c in which the third pointer image 302c is oriented in the angle determined.

The first pointer image 302a, the second pointer image 302b, the third pointer image 302c, and the fourth pointer image 302d are generically referred to as pointer images 302. The first mark image 304a, the second mark image 304b, the third mark image 304c, and the fourth mark image 304d are generically referred to as mark images 304. The first outer frame image 306a, the second outer frame image 306b, the third outer frame image 306c, and the fourth outer frame image 306d are generically referred to as outer frame images 306. The first dial face image 308a, the second dial face image 308b, the third dial face image 308c, and the fourth dial face image 308d are generically referred to as dial face images 308. The second unit image 310b, the third unit image 310c, and the fourth unit image 310d are generically referred to as unit images 310.

The display mode shown in FIG. 3A in which the first meter image 300a is included in the meter screen 400 is referred to as “the first mode” or “the first state”. The display mode shown in FIG. 3B in which the third meter image 300c is included in the meter screen 400 is referred to as “the second mode” or “the second state”. It can therefore be said that the display controller 228 can switch the display mode of the display panel 212 between the first mode and the second mode.

The first mode and the second mode are switched according to one of (A)-(C). (A) In the menu screen displayed on the display panel 212, the driver uses the user operation interface (not shown) of the steering wheel 54 to select a display mode. An instruction to select a display mode is received by the communication controller 220. An instruction to select a display mode is also referred to as user setting information. The display controller 228 displays the meter screen 400 according to the first mode or the second mode on the display panel 212 in accordance with the instruction to select a display mode received from the communication controller 220.

(B) In the menu screen displayed on the vehicle-mounted monitor 100, the driver uses the touch panel (not shown) to select a display mode. The instruction to select a display mode is received by the communication controller 220. The display controller 228 displays the meter screen 400 according to the first mode or the second mode on the display panel 212 in accordance with the instruction to select a display mode received from the communication controller 220.

(C) When the vehicle 10 can be driven automatically, it is predefined that the first mode is displayed during automatic driving, and the second mode is selected during manual driving. The communication controller 220 receives vehicle information indicating automatic driving or manual driving from the ECU. The display controller 228 displays the meter screen 400 according to the first mode or the second mode on the display panel 212 in accordance with the vehicle information received from the communication controller 220.

It will be useful if the driver can discern whether the meter screen 400 according to the first mode is displayed or the meter screen 400 according to the second mode is displayed on the display panel 212. The display controller 228 changes the display mode of at least one of the second meter image 300b, the third meter image 300c, the fourth meter image 300d , or the background image 312 when it switches from the first meter image 300a to the third meter image 300c and displays the third meter image 300c on the display panel 212. (1) First example through (15) fifteenth example will be sequentially described by way of specific examples.

### (1) First Example

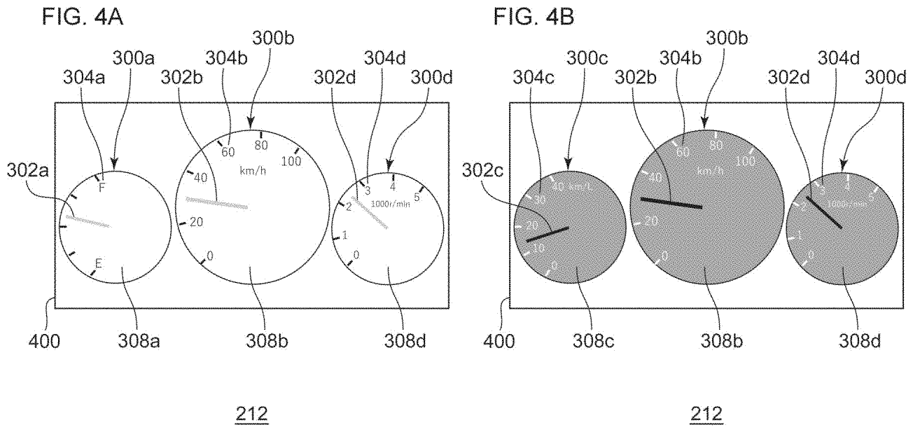

In the first example, different colors are used for the pointer image 302, the mark image 304, and the dial face image 308, respectively, in the first mode and the second mode. These colors are changed when the mode is switched from the first mode to the second mode. FIGS. 4A-4B show examples of the meter screen 400 displayed on the display panel 212. FIG. 4A shows the meter screen 400 in the first mode, and FIG. 4B shows the meter screen 400 in the second mode. Referring to FIG. 4A, each pointer image 302 is shown in “red”, each mark image 304 is shown in “white”, and each dial face image 308 is shown in “black” by way of example. Referring to FIG. 4B, each pointer image 302 is shown in “white”, each mark image 304 is shown in “black”, and each dial face image 308 is shown in “gray” by way of example.

In other other words, the display controller 228 changes the colors of the pointer image 302, the mark image 304, and the dial face image 308 of the third meter image 300c and the second meter image 300b in the second mode from those of the first meter image 300a and the second meter image 300b in the first mode. The display controller 228 may change at least one of luminance or brightness in addition to or independent of the color. The fourth meter image 300d may be processed in the same manner as the second meter image 300b. This holds true of the examples below.

### (2) Second Example

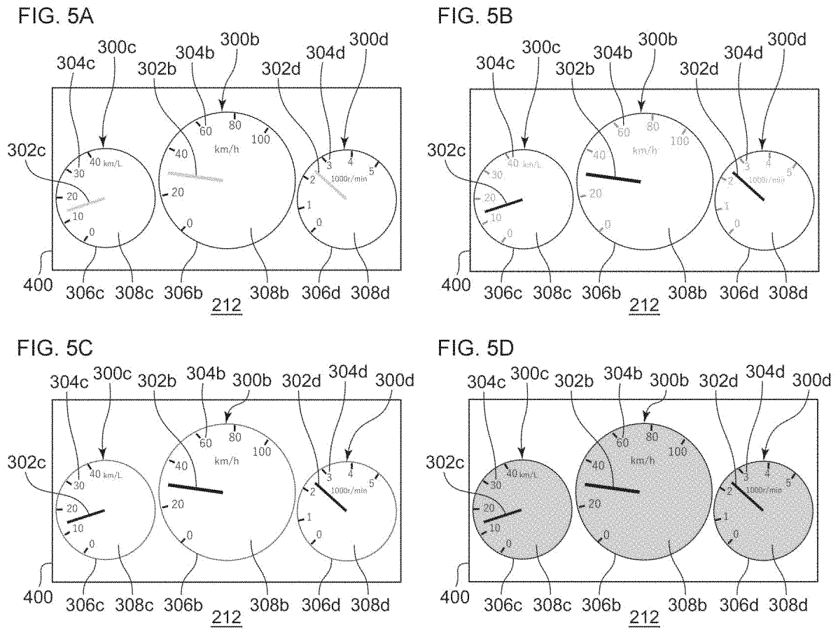

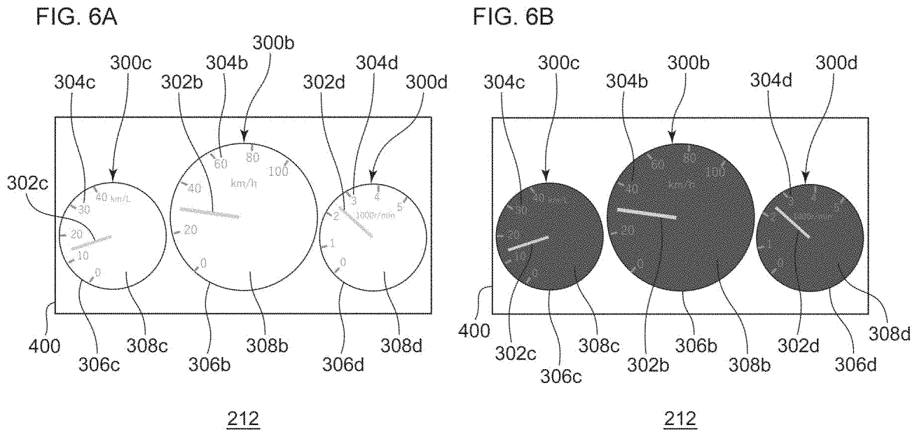

In the second example, at least one of the pointer image 302, the mark image 304, the dial face image 308, or the unit image 310 is changed to a different color when the mode is switched from the first mode to the second mode. For example, the meter screen 400 in the first mode is as shown in FIG. 3A. FIGS. 5A-5D show further examples of the meter screen 400 displayed on the display panel 212, and FIGS. 6A-6B show further examples of the meter screen 400 displayed on the display panel 212. FIGS. 5A-5D and FIGS. 6A-6B show the meter screens 400 in the second mode.

In the third pointer image 302c, the second pointer image 302b, and the fourth pointer image 302d of FIG. 5A, colors different from those of the first pointer image 302a, the second pointer image 302b, and the fourth pointer image 302d of FIG. 3A are used. When the mode is switched between the first mode and the second mode, the colors of the images other than the pointer images 302 are not changed. Referring to FIG. 3A, for example, each pointer image 302 is shown in “black”, and referring to FIG. 5A, each pointer image 302 is shown in “gray”. In the third mark image 304c, the second mark image 304b, and the fourth mark image 304d of FIG. 5B, colors different from those of the first mark image 304a, the second mark image 304b, and the fourth mark image 304d of FIG. 3A are used. When the mode is switched between the first mode and the second mode, the colors of the images other than the mark images 304 are not changed.

In the third outer frame image 306c, the second outer frame image 306b, and the fourth outer frame image 306d of FIG. 5C, colors different from those of the first outer frame image 306a, the second outer frame image 306b, and the fourth outer frame image 306d of FIG. 3A are used. When the mode is switched between the first mode and the second mode, the colors of the images other than the outer frame images 306 are not changed. In the third dial face image 308c, the second dial face image 308b, and the fourth dial face image 308d of FIG. 5D, colors different from those of the first dial face image 308a, the second dial face image 308b, and the fourth dial face image 308d of FIG. 3A are used. When the mode is switched between the first mode and the second mode, the colors of the images other than the dial face images 308 are not changed.

In the third pointer image 302c, the second pointer image 302b, and the fourth pointer image 302d of FIG. 6A, colors different from those of the first pointer image 302a, the second pointer image 302b, and the fourth pointer image 302d of FIG. 3A are used. Also, in the third mark image 304c, the second mark image 304b, and the fourth mark image 304d of FIG. 6A, colors different from those of the first mark image 304a, the second mark image 304b, and the fourth mark image 304d of FIG. 3A are used. When the mode is switched between the first mode and the second mode, the colors of the images other than the pointer images 302 and the mark images 304 are not changed.

In the third pointer image 302c, the second pointer image 302b, and the fourth pointer image 302d of FIG. 6B, colors different from those of the first pointer image 302a, the second pointer image 302b, and the fourth pointer image 302d of FIG. 3A are used. Also, in the third mark image 304c, the second mark image 304b, and the fourth mark image 304d of FIG. 6B, colors different from those of the first mark image 304a, the second mark image 304b, and the fourth mark image 304d of FIG. 3A are used. In the third outer frame image 306c, the second outer frame image 306b, and the fourth outer frame image 306d of FIG. 6B, colors different from those of the first outer frame image 306a, the second outer frame image 306b, and the fourth outer frame image 306d of FIG. 3A are used. In the third dial face image 308c, the second dial face image 308b, and the fourth dial face image 308d of FIG. 6B, colors different from those of the first dial face image 308a, the second dial face image 308b, and the fourth dial face image 308d of FIG. 3A are used.

In other words, the display controller 228 changes the color of at least one of the pointer image 302, the mark image 304, the outer frame image 306, or the dial face image 308 in the second meter image 300b and the third meter image 300c when switching from the first mode to the second mode. Alternatively, the display controller 228 may change the color of at least one of the pointer image 302, the mark image 304, the outer frame image 306, or the dial face image 308 in one of the second meter image 300b and the third meter image 300c when switching from the first mode to the second mode. Further, the display controller 228 may change at least one of brightness or luminance in addition to or independent of the color. The display controller 228 may change the lighting time of at least one of the pointer image 302, the mark image 304, the outer frame image 306, or the dial face image 308 in at least one of the second meter image 300b or the third meter image 300c when switching from the first mode to the second mode. For example, the display controller 228 may light the pointer image 302 of each meter image 300 always in the first mode and may cause the pointer image 302 of each meter image 300 to flash in the second mode. For example, the display controller 228 can light the pointer image 302 always by configuring the lighting time to be long and can cause the pointer image 302 to flash by configuring the lighting time to be short.

### (3) Third Example

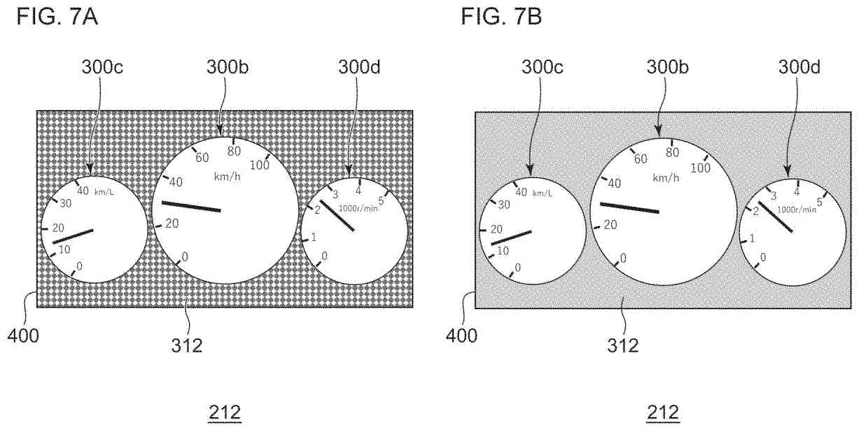

In the third example, the design or color of the background image 312 is changed when the mode is switched from the first mode to the second mode. For example, the meter screen 400 in the first mode is as shown in FIG. 3A. FIGS. 7A-7B show still further examples of the meter screen 400 displayed on the display panel 212. FIGS. 7A-7B show the meter screens 400 in the second mode. The background image 312 of FIG. 7A is patterned, and the background image 312 of FIG. 3A is not patterned. Stated other words, the background image 312 of FIG. 3A is in a solid color. The display mode of the images other than the background image 312 is not changed when the mode is switched between the first mode and the second mode. In the background image 312 of FIG. 7B, a color different from that of the background image 312 of FIG. 3A is used. The color of the images other than the background image 312 is not changed when the mode is switched between the first mode and the second mode. In other words, the display controller 228 changes at least one of the color or design of the background image 312 when switching from the first mode to the second mode.

### (4) Fourth Example

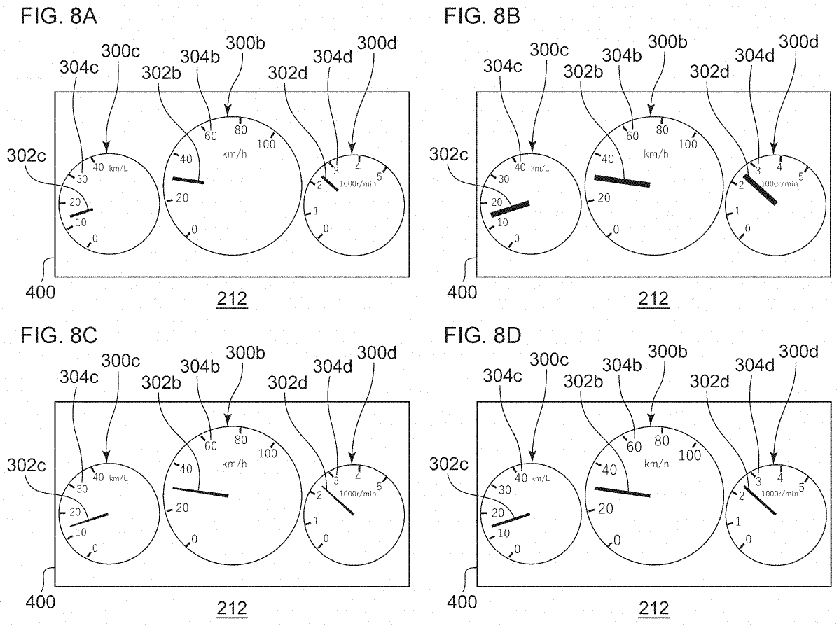

In the fourth example, at least one of the length, boldness, or shape of the pointer image 302 is changed when the mode is switched from the first mode to the second mode. For example, the meter screen 400 in the first mode is as shown in FIG. 3A. FIGS. 8A-8C show still further examples of the meter screen 400 displayed on the display panel 212. FIGS. 8A-8C show the meter screens 400 in the second mode. The third pointer image 302c , the second pointer image 302b, and the fourth pointer image 302d of FIG. 8A are shorter than the first pointer image 302a, the second pointer image 302b, and the fourth pointer image 302d of FIG. 3A. In this example, the boldness and shape of the pointer image 302 are the same in the first mode and the second mode. The third pointer image 302c, the second pointer image 302b, and the fourth pointer image 302d of FIG. 8B are bolder than the first pointer image 302a, the second pointer image 302b, and the fourth pointer image 302d of FIG. 3A. In this example, the length and shape of the pointer image 302 are the same in the first mode and the second mode.

The third pointer image 302c, the second pointer image 302b, and the fourth pointer image 302d of FIG. 8C have a trapezoidal shape, and the first pointer image 302a, the second pointer image 302b, and the fourth pointer image 302d of FIG. 3A have a rectangular shape. Stated otherwise, the shape of the pointer image 302 differs in the first mode and the second mode. In this example, the length and boldness of the pointer image 302 are the same in the first mode and the second mode. In other words, the display controller 228 changes at least one of the size or shape of the pointer image 302 in the second meter image 300b and the third meter image 300c when switching from the first mode to the second mode. Alternatively, the display controller 228 may change at least one of the size or shape of the pointer image 302 in one of the second meter image 300b and the third meter image 300c when switching from the first mode to the second mode.

### (5) Fifth Example

In the fifth example, the size of the character of the mark image 304 is changed when the mode is switched from the first mode to the second mode. For example, the meter screen 400 in the first mode is as shown in FIG. 3A. FIG. 8D shows a still further example of the meter screen 400 displayed on the display panel 212. FIG. 8D shows the meter screen 400 in the second mode. The third mark image 304c, the second mark image 304b, and the fourth mark image 304d of FIG. 8D are larger than the first mark image 304a, the second mark image 304b, and the fourth mark image 304d of FIG. 3A. In other words, the display controller 228 changes the size of the mark image 304 in the second meter image 300b and the third meter image 300c when switching from the first mode to the second mode. Alternatively, the display controller 228 may change the size of the mark image 304 in one of the second meter image 300b and the third meter image 300c when switching from the first mode to the second mode.

### (6) Sixth Example

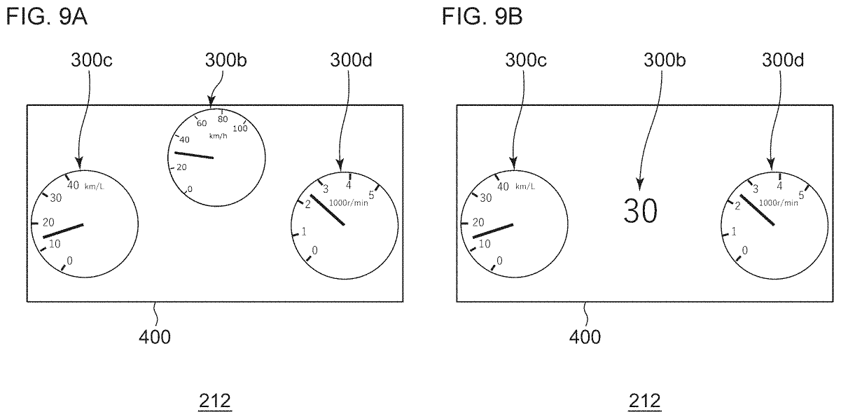

In the sixth example, the size of the meter image 300 is changed when the mode is switched from the first mode to the second mode. FIG. 9A shows a still further example of the meter screen 400 displayed on the display panel 212. FIG. 9A shows the meter screen 400 in the second mode. The second meter image 300b of FIG. 9A is smaller than the second meter image 300b of FIG. 3A. Alternatively, the second meter image 300b in the second mode may be larger than the second meter image 300b in the first mode. In other words, the display controller 228 changes the size of the second meter image 300b when switching from the first mode to the second mode. Alternatively, the display controller 228 may change the size of the third meter image 300c when switching from the first mode to the second mode. Alternatively, the display controller 228 may change the size of the second meter image 300b and the third meter image 300c when switching from the first mode to the second mode.

### (7) Seventh Example

In the seventh example, the meter image 300 is changed from an analog display mode to a digital display mode when the mode is switched from the first mode to the second mode. For example, the meter screen 400 in the first mode is as shown in FIG. 3A. FIG. 9B shows a still further example of the meter screen 400 displayed on the display panel 212. FIG. 9B shows the meter screen 400 in the second mode. The second meter image 300b of FIG. 9B is displayed in a digital mode, and the second meter image 300b of FIG. 3A is displayed in an analog mode. In other words, the display controller 228 displays the second meter image 300b in a digital mode when switching from the first mode to the second mode. Alternatively, the display controller 228 may display the third meter image 300c in a digital mode when switching from the first mode to the second mode. Alternatively, the display controller 228 may display the second meter image 300b and the third meter image 300c in a digital mode when switching from the first mode to the second mode.

### (8) Eighth Example

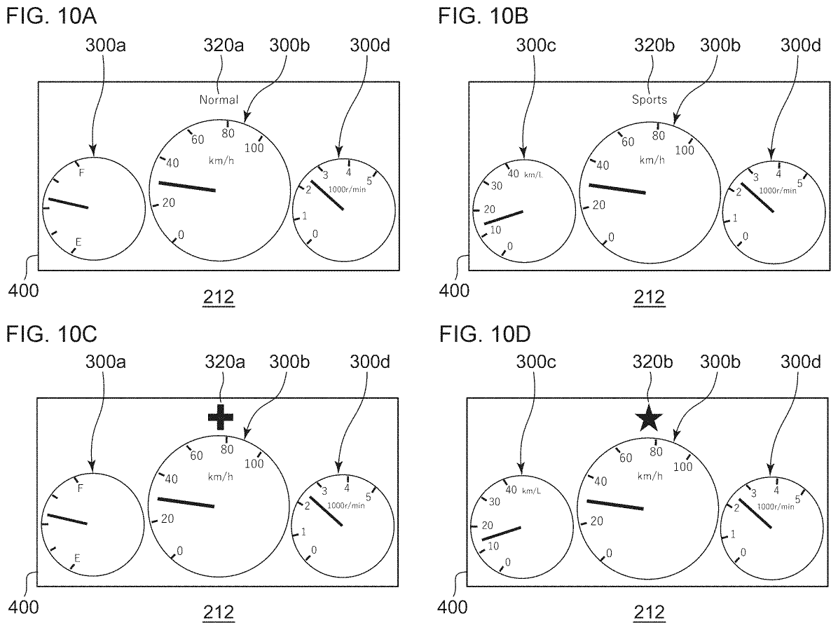

In the eighth example, an image indicating a display mode is provided in the meter screen 400. The image indicating a display mode will be referred to as a “mode image”. In the eighth example, the mode image is switched when the mode is switched from the first mode to the second mode. By way of one example, the first mode is referred to as a “normal mode”, and the second mode is referred to as a “sports mode”. FIGS. 10A-10D show still further examples of the meter screen 400 displayed on the display panel 212. FIG. 10A shows the meter screen 400 in the first mode, and FIG. 10B shows the meter screen 400 in the second mode.

The meter screen 400 of FIG. 10A includes, as in FIG. 3A, the first meter image 300a, the second meter image 300b, and the fourth meter image 300d. Further, a first mode image 320a is provided above the second meter image 300b in the meter screen 400 of FIG. 10A. The first mode image 320a is an image to indicate the first mode. In this case, the first mode image 320a shows characters “Normal”. The meter screen 400 of FIG. 10B includes the third meter image 300c, the second meter image 300b, and the fourth meter image 300d. Further, a second mode image 320b is provided above the second meter image 300b in the meter screen 400 of FIG. 10B. The second mode image 320b is an image to indicate the second mode. In this case, the second mode image 320b shows characters “Sports”. When the mode is switched from the first mode to the second mode, therefore, the first meter image 300a is switched to the third meter image 300c , and the first mode image 320a is switched to the second mode image 320b.

Like FIG. 10A, FIG. 10C shows the meter screen 400 in the first mode. In FIG. 10C, the first mode image 320a is, unlike that of FIG. 10A, a crisscross mark. Like FIG. 10B, FIG. 10D shows the meter screen 400 in the second mode. In FIG. 10D, the second mode image 320b is, unlike that of FIG. 10B, a star-shaped mark. The first mode image 320a and the second mode image 320b are generically referred to as mode images 320. In other words, the display controller 228 displays the first meter image 300a and the first mode image 320a on the display panel 212 in the first mode and displays the third meter image 300c and the second mode image 320b on the display panel 212 in the second mode.

### (9) Ninth Example

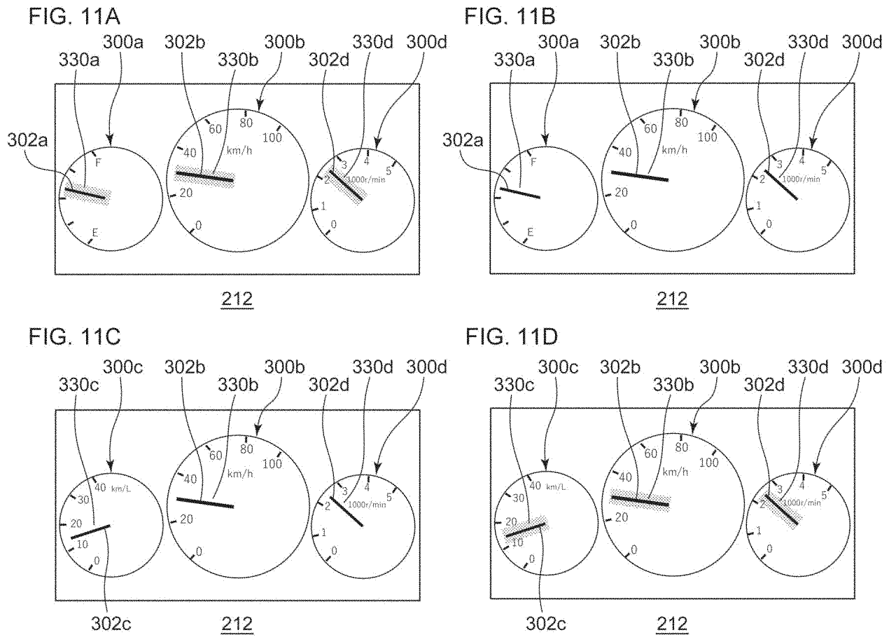

In the ninth example, a pointer fringe area is provided around the pointer image 302. In the ninth example, the pointer fringe area is lighted in the first mode. When the mode is switched from the first mode to the second mode, the brightness of the pointer fringe area is lowered, and then the brightness of the pointer fringe area is increased in the second mode. FIGS. 11A-11D show still further examples of the meter screen 400 displayed on the display panel 212.

FIG. 11A shows the meter screen 400 in the first mode. The meter screen 400 includes, in addition to what is shown in the meter screen 400 of FIG. 3A, a first pointer fringe area 330a, a second pointer fringe area 330b, and a fourth pointer fringe area 330d. The first pointer fringe area 330a, the second pointer fringe area 330b, a third pointer fringe area 330c (described later), and the fourth pointer fringe area 330d are generically referred to as pointer fringe areas 330. The first pointer fringe area 330a is an area provided around the first pointer image 302a. The second pointer fringe area 330b is an area provided around the second pointer image 302b. The fourth pointer fringe area 330d is an area provided around the fourth pointer image 302d. The first pointer fringe area 330a, the second pointer fringe area 330b, and the fourth pointer fringe area 330d are lighted in, for example, “white” with a predetermined brightness in the first mode.

FIG. 11B shows the meter screen 400 shown immediately before the mode is switched from the first mode to the second mode. In FIG. 11B, the brightness of the first pointer fringe area 330a, the second pointer fringe area 330b, and the fourth pointer fringe area 330d is lowered as compared with FIG. 11A. The first pointer fringe area 330a, the second pointer fringe area 330b, and the fourth pointer fringe area 330d may not be lighted.

FIG. 11C shows the meter screen 400 shown immediately after the mode is switched from the first mode to the second mode. The meter screen 400 includes, in addition to what is shown in the meter screen 400 of FIG. 3B, the third pointer fringe area 330c, the second pointer fringe area 330b, and the fourth pointer fringe area 330d. The third pointer fringe area 330c is an area provided around the third pointer image 302c. The brightness of the third pointer fringe area 330c, the second pointer fringe area 330b, and the fourth pointer fringe area 330d is, for example, the same as that of the pointer fringe areas 330 of FIG. 11B.

FIG. 11D shows a state that follows FIG. 11C and shows the meter screen 400 in the second mode. The brightness of the third pointer fringe area 330c, the second pointer fringe area 330b, and the fourth pointer fringe area 330d is, for example, the same as that of the pointer fringe areas 330 of FIG. 11A. In other words, the display controller 228 lowers the brightness of the pointer fringe area 330 and returns it to original in the second meter image 300b and the third meter image 300c when switching from the first mode to the second mode. Alternatively, the display controller 228 may lower the brightness of the pointer fringe area 330 and returns it to original in one of the second meter image 300b and the third meter image 300c when switching from the first mode to the second mode.

### (10) Tenth Example

In the tenth example, the brightness of the pointer fringe area 330 is increased when the mode is switched from the first mode to the second mode. The meter screen 400 in the first mode is the same as that of FIG. 11A. The first pointer fringe area 330a, the second pointer fringe area 330b, and the fourth pointer fringe area 330d are lighted in, for example, “white” with a predetermined brightness in the first mode. The meter screen 400 in the second mode shown as a result of switching from the first mode is the same as that of FIG. 11D. The brightness of the third pointer fringe area 330c, the second pointer fringe area 330b, and the fourth pointer fringe area 330d is higher than, for example, that of the pointer fringe areas 330 in the meter screen 400 in the first mode. The brightness of the third pointer fringe area 330c, the second pointer fringe area 330b, and the fourth pointer fringe area 330d may be lower than, for example, that of the pointer fringe areas 330 in the meter screen 400 in the first mode.

In other words, the display controller 228 changes the brightness of the pointer fringe area 330 in the second meter image 300b and the third meter image 300c when switching from the first mode to the second mode. Alternatively, the display controller 228 may change the brightness of the pointer fringe area 330 in one of the second meter image 300b and the third meter image 300c when switching from the first mode to the second mode.

### (11) Eleventh Example

In the eleventh example, the pointer fringe area 330 is changed from the lighted state to the flashing state when the mode is switched from the first mode to the second mode. The meter screen 400 in the first mode is the same as that of FIG. 11A. The first pointer fringe area 330a, the second pointer fringe area 330b, and the fourth pointer fringe area 330d are lighted in, for example, “white” with a predetermined brightness in the first mode. The meter screen 400 in the second mode shown as a result of switching from the first mode is the same as that of FIG. 11D. In the meter screen 400 in the second mode the third pointer fringe area 330c, the second pointer fringe area 330b, and the fourth pointer fringe area 330d flash. The interval of flashing is predetermined. Further, the brightness of the third pointer fringe area 330c, the second pointer fringe area 330b, and the fourth pointer fringe area 330d lighted in the flashing mode is, for example, the same as that of the pointer fringe areas 330 in the meter screen 400 in the first mode.

In other words, the display controller 228 changes the lighting time of the pointer fringe area 330 in the second meter image 300b and the third meter image 300c when switching from the first mode to the second mode. Alternatively, the display controller 228 may change the lighting time of the pointer fringe area 330 in one of the second meter image 300b and the third meter image 300c when switching from the first mode to the second mode.

### (12) Twelfth Example

In the twelfth example, the luminance of the pointer fringe area 330 is increased when the mode is switched from the first mode to the second mode. The meter screen 400 in the first mode is the same as that of FIG. 11A. The first pointer fringe area 330a, the second pointer fringe area 330b, and the fourth pointer fringe area 330d are lighted in, for example, “red” with a predetermined luminance in the first mode. The meter screen 400 in the second mode shown as a result of switching from the first mode is the same as that of FIG. 11D. The luminance of the third pointer fringe area 330c, the second pointer fringe area 330b, and the fourth pointer fringe area 330d is, for example, configured to be higher than that of the pointer fringe area 330 in the meter screen 400 in the first mode.

In other words, the display controller 228 changes the luminance of the pointer fringe area 330 in the second meter image 300b and the third meter image 300c when switching from the first mode to the second mode. Alternatively, the display controller 228 may change the luminance of the pointer fringe area 330 in one of the second meter image 300b and the third meter image 300c when switching from the first mode to the second mode.

### (13) Thirteenth Example

In the thirteenth example, the color of one of the pointer fringe areas 330 is changed, and the color of the rest of the pointer fringe areas 330 is not changed when the mode is switched from the first mode to the second mode. The meter screen 400 in the first mode is the same as that of FIG. 11A. The first pointer fringe area 330a, the second pointer fringe area 330b, and the fourth pointer fringe area 330d are lighted in, for example, “white” in the first mode. The meter screen 400 in the second mode shown as a result of switching from the first mode is the same as that of FIG. 11D. The third pointer fringe area 330c is changed to, for example, “red” in the second mode. Meanwhile, the second pointer fringe area 330b and the fourth pointer fringe area 330d remain “white” in the second mode. Thus, the color of the pointer fringe area 330 only in the post-switching meter image 300 is changed when the mode is changed from the first mode to the second mode.

In other words, the display controller 228 changes the color of the pointer fringe area 330 in the third meter image 300c and does not change the color of the second pointer fringe area 330b in the second meter image 300b when switching from the first mode to the second mode. Alternatively, the display controller 228 may not change the color of the pointer fringe area 330 in the third meter image 300c and change the color of the second pointer fringe area 330b in the second meter image 300b when switching from the first mode to the second mode.

### (14) Fourteenth Example

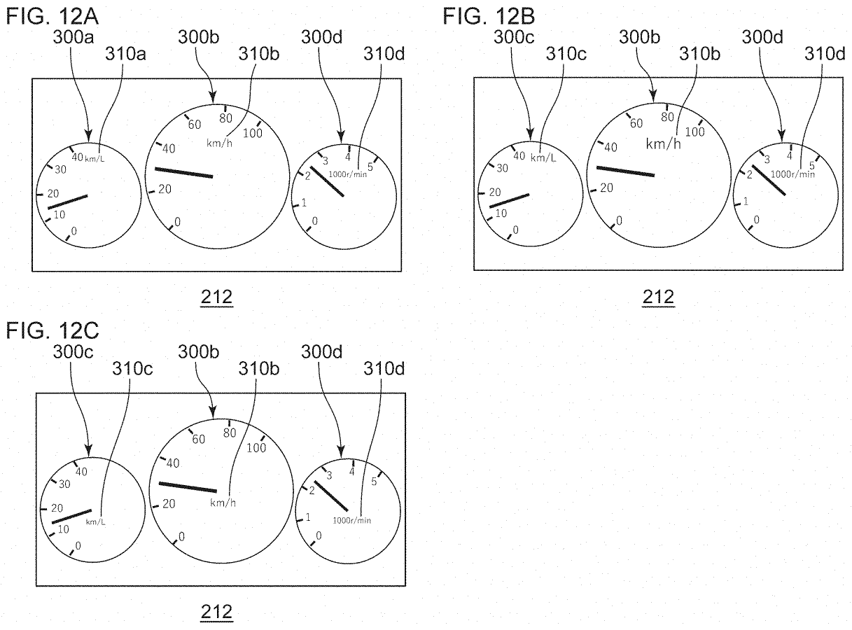

In the fourteenth example, at least one of the size, display position, or displayed distance between a numeral and a unit is changed when the mode is switched from the first mode to the second mode. FIGS. 12A-12C show still further examples of the meter screen 400 displayed on the display panel 212. FIG. 12A shows the meter screen 400 in the first mode. In FIG. 12A, as in FIG. 3A, the first meter image 300a, the second meter image 300b, and the fourth meter image 300d are arranged from left to right. The first meter image 300a is, for example, an image of an average fuel cost meter. The first meter image 300a of FIG. 12A further includes a first unit image 310a. Further, the first unit image 310a, the second unit image 310b, and the fourth unit image 310d are provided toward the top of the respective meter images 300. The display controller 228 of FIG. 2 determines the angle of the first pointer image 302a relative to the first mark image 304a based on the average fuel const information received from the communication controller 220 and generates the first meter image 300a in which the first pointer image 302a is oriented in the angle determined.

FIG. 12B shows the meter screen 400 in the second mode. In FIG. 12B, as in FIG. 3B, the third meter image 300c, the second meter image 300b, and the fourth meter image 300d are arranged from left to right. The third meter image 300c is, for example, an image of an instantaneous fuel cost meter. The display controller 228 of FIG. 2 determines the angle of the third pointer image 302c relative to the third mark image 304c based on the instantaneous fuel cost information received from the communication controller 220 and generates the third meter image 300c in which the third pointer image 302c is oriented in the angle determined. In that process, the size of the third unit image 310c, the second unit image 310b, and the fourth unit image 310d in FIG. 12B is larger than that of the first unit image 310a, the second unit image 310b, and the fourth unit image 310d in FIG. 12A.

FIG. 12C shows another example of the meter screen 400 in the second mode. The third unit image 310c, the second unit image 310b, and the fourth unit image 310d in FIG. 12C are provided in the central portion of the respective meter images 300. Stated otherwise, the position of the unit image 310 is changed when the mode is switched from the first mode to the second mode.

In other words, the display controller 228 changes at least one of the size of the unit image 310 or the position of the unit image 310 in the second meter image 300b and the third meter image 300c when switching from the first mode to the second mode. Alternatively, the display controller 228 may change at least one of the size of the unit image 310 or the position of the unit image 310 in one of the second meter image 300b and the third meter image 300c when switching from the first mode to the second mode.

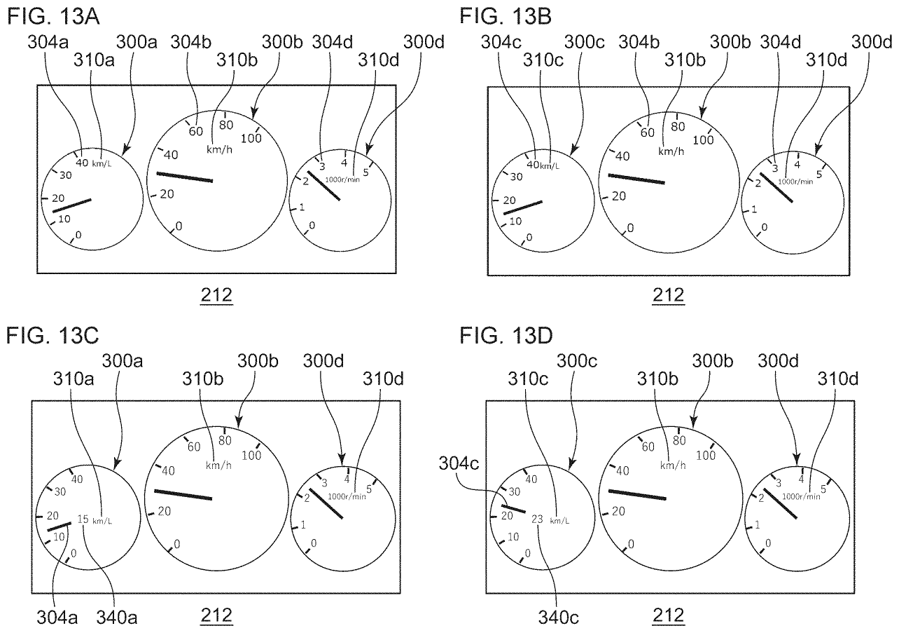

FIGS. 13A-13D show still further examples of the meter screen 400 displayed on the display panel 212. FIG. 13A shows the meter screen 400 in the first mode. In FIG. 13A, the first meter image 300a, the second meter image 300b, and the fourth meter image 300d are arranged from left to right. In FIG. 13A, the first meter image 300a is, for example, an image of an average fuel cost meter. In FIG. 13A, a numeral “40” and the first unit image 310a in the first mark image 304a are arranged horizontally. FIG. 13B shows the meter screen 400 in the second mode. In FIG. 13B, the third meter image 300c, the second meter image 300b, and the fourth meter image 300d are arranged from left to right. In FIG. 13B, the third meter image 300c is, for example, an image of an instantaneous fuel cost meter. In FIG. 13B, a numeral “40” and the third unit image 310c in the third mark image 304c are arranged horizontally.

The distance between the numeral “40” and the third unit image 310c in the third mark image 304c is smaller than the distance between the numeral “40” and the first unit image 310a in the first mark image 304a. The distance between the numeral “40” and the third unit image 310c in the third mark image 304c may be larger than the distance between the numeral “40” and the first unit image 310a in the first mark image 304a. In other words, the display controller 228 changes the distance between the numeral of the mark and the third unit image 310c in the third meter image 300c when switching from the first mode to the second mode. In other words, the display controller 228 may change the distance between the numeral of the mark and the unit image 310 in the second meter image 300b and the third meter image 300c when switching from the first mode to the second mode.

FIG. 13C shows another example of the meter screen 400 in the first mode. In FIG. 13C, the first meter image 300a, the second meter image 300b, and the fourth meter image 300d are arranged from left to right. In FIG. 13C, the first meter image 300a is, for example, an image of an average fuel cost meter. In FIG. 13C, a first numeral image 340a and the first unit image 310a are arranged horizontally in the central portion of the first meter image 300a. The first numeral image 340a is an image digitally representing the value pointed to by the pointer in the first mark image 304a. FIG. 13D shows another example of the meter screen 400 in the second mode. In FIG. 13D, the third meter image 300c, the second meter image 300b, and the fourth meter image 300d are arranged from left to right. In FIG. 13D, the third meter image 300c is, for example, an image of an instantaneous fuel cost meter. In FIG. 13D, a third numeral image 340c and the third unit image 310c are arranged horizontally in the central portion of the third meter image 300c. The third numeral image 340c is an image digitally representing the value pointed to by the pointer in the third mark image 304c.

The distance between the third numeral image 340c and the third unit image 310c is larger than the distance between the first numeral image 340a and the first unit image 310a. The distance between the third numeral image 340c and the third unit image 310c may be smaller than the distance between the first numeral image 340a and the first unit image 310a.

In other words, the display controller 228 changes the distance between the third numeral image 340c and the third unit image 310c displayed next to each other in the third meter image 300c when switching from the first mode to the second mode. The display controller 228 may change the distance between the numeral image 340 and the unit image 310 displayed next to each other in the second meter image 300b and the third meter image 300c when switching from the first mode to the second mode.

### (15) Fifteenth Example

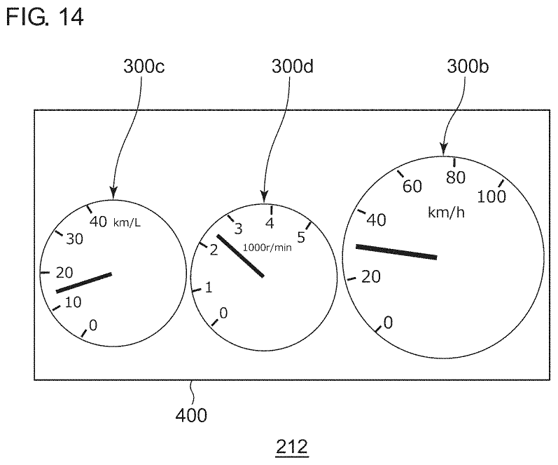

In the fifteenth example, the arrangement of the meter images 300 is changed when the mode is switched from the first mode to the second mode. FIG. 14 shows a still further example of the meter screen 400 displayed on the display panel 212. FIG. 14 shows the meter screen 400 in the second mode. In FIG. 14, the third meter image 300c, the fourth meter image 300d, and the second meter image 300b are arranged from left to right. In other words, the display controller 228 changes the arrangement of at least one of the second meter image 300b or the third meter image 300c by switching the positions of the second meter image 300b and the fourth meter image 300d when switching from the first mode to the second mode. Alternatively, the display controller 228 may change the arrangement of at least one of the second meter image 300b or the third meter image 300c by switching between the position of the third meter image 300c and the position of the second meter image 300b or the fourth meter image 300d when switching from the first mode to the second mode.

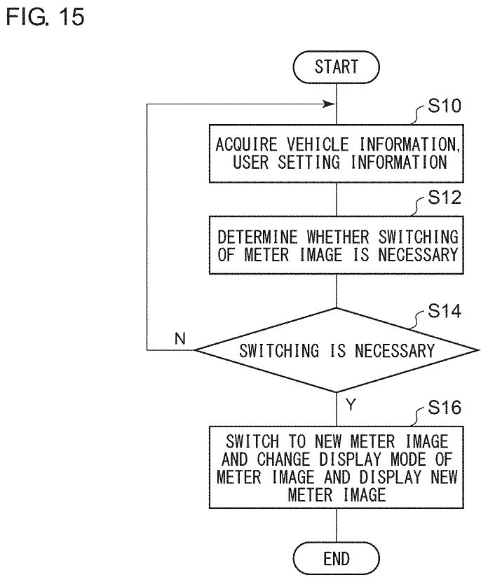

A description will be given of the operation of the display apparatus 200 having the above-described configuration. FIG. 15 is a flowchart showing a sequence of displaying steps in the display apparatus 200. The communication controller 220 acquires vehicle information and user setting information (S10). The display controller 228 determines whether switching of the meter image 300 is necessary (S12). When switching is not necessary (N in S14), control returns to step 10. When switching is necessary (Y in S14), the display controller 228 switches to the new meter image 300 and displays the meter image 300, changing the display mode thereof (S16).

According to the embodiment, the display mode of at least one of the second meter image, the third meter image, or the background image is changed when the first meter image is switched to the third meter image, which is displayed on the display panel. Therefore, recognition of the switching of the meter image is facilitated. Since at least one of the color, brightness, luminance, lighting time, size, or shape of at least some areas is changed, recognition of the switching of the meter image is facilitated. Further, since at least one of the color, brightness, luminance, and lighting time of at least one of the pointer image, mark image, outer frame image, or dial face image is changed, recognition of the switching of the meter image is facilitated. Further, since at least one of the size or shape of at least one of the pointer image or the mark image is changed, recognition of the switching of the meter image is facilitated. Further, since at least one of the brightness, luminance, or lighting time of the pointer fringe area is changed, recognition of the switching of the meter image is facilitated. Further, since the color of the pointer fringe area positioned around the pointer image of the third meter image and the color of the second pointer fringe area positioned around the pointer image of the second meter image is not changed, recognition of the switching of the meter image is facilitated.

Further, since the size of at least one of the second meter image or the third meter image is changed, recognition of the switching of the meter image is facilitated. Further, since the analog presentation is switched to the digital presentation, recognition of the switching of the meter image is facilitated. Further, since at least one of the color or design of the background image is changed, recognition of the switching of the meter image is facilitated. Further, since the first mode image is switched to the second mode image, recognition of the switching of the meter image is facilitated. Further, since at least one of the size of the unit image, position of the unit image, or distance between the mark and the unit image is changed, recognition of the switching of the meter image is facilitated. Further, since the distance between the numeral image and the unit image displayed next to each other is changed, recognition of the switching of the meter image is facilitated.

A summary of an embodiment of the present disclosure is given below. A display apparatus according to an embodiment of the present disclosure includes: a display panel capable of displaying one or more meter images, each of the one or more meter images includes a pointer image constituting a pointer and a mark image constituting a mark pointed to by the pointer; and a display controller that controls a display state of the display panel. The one or more meter images include a plurality of meter images, the display panel simultaneously displays the plurality of meter images including a first meter image and a second meter image and a background image encircling the plurality of meter images and is capable of switching from a first state of displaying the first meter image to a second state of displaying a third meter image, the third image is a meter image of a type different from the first meter image, and the display controller changes a display mode of at least one of the second meter image, the third meter image, or the background image when switching from the first state to the second state.

The display controller changes at least one of a color, brightness, luminance, lighting time, size, or shape of at least one area in at least one of the second meter image or the third meter image.

The each of the one or more meter images further includes an outer frame image constituting an outer frame encircling the mark and a dial face image constituting a dial face positioned inside the outer frame, wherein the display controller changes at least one of a color, brightness, luminance, or lighting time of at least one of the pointer image, the mark image, the outer frame image, or the dial face image in at least one of the second meter image or the third meter image.

The display controller changes at least one of a size or shape of at least one of the pointer image or the mark image in at least one of the second meter image or the third meter image.

The display controller changes at least one of a brightness, luminance, or lighting time of a pointer fringe area positioned around the pointer image in at least one of the second meter image or the third meter image.

The display controller changes a color of a first pointer fringe area positioned around the pointer image in the third meter image and does not change a color of a second pointer fringe area positioned around the pointer image in the second meter image.

The display controller changes a size of at least one of the second meter image or the third meter image.

The display controller displays at least one of the second meter image or the third meter image in a digital mode.

The display controller changes at least one of a color or design of the background image.

The display controller is capable of switching a display mode of the display panel between a first mode and a second mode, displays, in the first mode, the first meter image and a first mode image indicating the first mode on the display panel, and displays, in the second mode, the third meter image and a second mode image indicating the second mode on the display panel.

The each of the one or more meter images further includes a unit image indicating a unit of the mark. The display controller changes at least one of a size of the unit image, a position of the unit image, or a distance between the mark and the unit image in at least one of the second meter image or the third meter image.

The each of the one or more meter images further includes a numeral image constituting a numeral pointed to by the pointer and a unit image indicating a unit of the mark. The display controller changes a distance between the numeral image and the unit image displayed in an array in at least one of the second meter image or the third meter image.

The display controller changes an arrangement of at least one of the second meter image or the third meter image.

Given above is a description of the present disclosure based on an exemplary embodiment. The embodiment is intended to be illustrative only and it will be understood by those skilled in the art that various modifications to constituting elements and processes could be developed and that such modifications are also within the scope of the present disclosure.

When the mode is switched from the first mode to the second mode in the first example, second example, the fourth example, the fifth example, the ninth through twelfth examples, and fourteenth example of the embodiment, the third meter image 300c and the second meter image 300b may be changed to the same state. Alternatively, only the second meter image 300b may be changed. Changing the third meter image 300c and the second meter image 300b to the same state makes it easier for the driver to notice that the meter image 300 is switched. Further, changing only the second meter image 300b makes it easier for the driver to know which meter image 300 is switched.

The first example through the fifteenth example of the embodiment may be combined as desired. For example, the third pointer fringe area 330c of the third meter image 300c may be lighted in white and the second pointer fringe area 330b of the second meter image 300b may be caused to flash in red when the mode is switched from the first mode to the second mode. Alternatively, the third pointer fringe area 330c of the third meter image 300c may be lighted in white with a varying brightness and the second pointer fringe area 330b of the second meter image 300b may be caused to flash in white when the mode is switched from the first mode to the second mode. According to this variation, it is possible to make it easier for the driver to know that the meter image 300 is switched.

When the mode is switched from the first mode to the second mode in the sixth example, seventh example, and thirteenth example of the embodiment, the state of the third meter image 300c and that the second meter image 300b may be reversed. For example, the third pointer fringe area 330c of the third meter image 300c may be displayed in red, and the second pointer fringe area 330b of the second meter image 300b may be displayed in white in the thirteenth example. According to this variation, the flexibility in the configuration is improved.

When the mode is switched from the first mode to the second mode in the ninth example, tenth example, and twelfth example of the embodiment, the third meter image 300c and the second meter image 300b may be changed identically or differently. An example of the former is increasing the brightness of both images, and an example of the latter is lowering the brightness of the third meter image 300c and increasing the brightness of the second meter image 300b. Changing the third meter image 300c and the second meter image 300b identically simplifies the process in the display apparatus 200. Further, changing the third meter image 300c and the second meter image 300b differently lets the driver know which meter image 300 is switched easily.

When the mode is switched from the first mode to the second mode in the first example and the second example of the embodiment, the features in the third meter image 300c and the second meter image 300b may be changed to the same color or different colors. Changing the features in the third meter image 300c and the second meter image 300b to the same color simplifies the process in the display apparatus 200. Changing the features in the third meter image 300c and the second meter image 300b to different colors lets the driver know which meter image 300 is switched easily.

The ninth example through the twelfth example of the embodiment may be applied to the range other than the pointer fringe area 330. Further, the brightness or luminance may be changed instead of the color. According to this variation, the flexibility in the configuration is improved.

In the embodiment, the post-change state may be maintained or returned to original after an elapse of a predetermined period of time. According to this variation, the flexibility in the configuration is improved.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the benefit of priority from the prior Japanese Patent Application No. 2021-77719, filed on Apr. 30, 2021, the entire contents of which are incorporated herein by reference.

What is claimed is:

1. A display apparatus comprising:
a display panel capable of displaying one or more meter images, each of the one or more meter images includes a pointer image constituting a pointer and a mark image constituting a mark pointed to by the pointer; and
a display controller that controls a display state of the display panel, wherein
the one or more meter images include a plurality of meter images,
the display panel simultaneously displays the plurality of meter images including a first meter image and a second meter image and a background image encircling the plurality of meter images and is capable of switching from a first state of displaying the first meter image to a second state of displaying a third meter image, the third image is a meter image of a type different from the first meter image, and
the display controller changes a display mode of at least one of the second meter image, the third meter image, or the background image when switching from the first state to the second state.

2. The display apparatus according to claim 1, wherein
the display controller changes at least one of a color, brightness, luminance, lighting time, size, or shape of at least one area in at least one of the second meter image or the third meter image.

3. The display apparatus according to claim 2, wherein
the each of the one or more meter images further includes an outer frame image constituting an outer frame encircling the mark and a dial face image constituting a dial face positioned inside the outer frame, wherein
the display controller changes at least one of a color, brightness, luminance, or lighting time of at least one of the pointer image, the mark image, the outer frame image, or the dial face image in at least one of the second meter image or the third meter image.

4. The display apparatus according to claim 2, wherein
the display controller changes at least one of a size or shape of at least one of the pointer image or the mark image in at least one of the second meter image or the third meter image.

5. The display apparatus according to claim 2, wherein
the display controller changes at least one of a brightness, luminance, or lighting time of a pointer fringe area positioned around the pointer image in at least one of the second meter image or the third meter image.

6. The display apparatus according to claim 2, wherein
the display controller changes a color of a first pointer fringe area positioned around the pointer image in the third meter image and does not change a color of a second pointer fringe area positioned around the pointer image in the second meter image.

7. The display apparatus according to claim 1, wherein
the display controller changes a size of at least one of the second meter image or the third meter image.

8. The display apparatus according to claim 1, wherein
the display controller displays at least one of the second meter image or the third meter image in a digital mode.

9. The display apparatus according to claim 1, wherein
the display controller changes at least one of a color or design of the background image.

10. The display apparatus according to claim 1, wherein
the display controller is capable of switching a display mode of the display panel between a first mode and a second mode, displays, in the first mode, the first meter image and a first mode image indicating the first mode on the display panel, and displays, in the second mode, the third meter image and a second mode image indicating the second mode on the display panel.

11. The display apparatus according to claim 1 wherein
the each of the one or more meter images further includes a unit image indicating a unit of the mark, and
the display controller changes at least one of a size of the unit image, a position of the unit image, or a distance between the mark and the unit image in at least one of the second meter image or the third meter image.

12. The display apparatus according to claim 1, wherein
the each of the one or more meter images further includes a numeral image constituting a numeral pointed to by the pointer and a unit image indicating a unit of the mark, and
the display controller changes a distance between the numeral image and the unit image displayed in an array in at least one of the second meter image or the third meter image.

13. The display apparatus according to claim 1, wherein
the display controller changes an arrangement of at least one of the second meter image or the third meter image.
